(19) United States
(12) Patent Application Publication
(10) Pub. No.: US 2025/0158528 A1
(43) Pub. Date: May 15, 2025

(54) BALANCING TEMPERATURES OF POWER STAGES OF A MULTI-PHASE SWITCHING CONVERTER

(71) Applicant: Shaoxing Yuanfang Semiconductor Co., Ltd., Shaoxing (CN)

(72) Inventors: Pedro Filipe Francisco Marques, Armés (PT); Michael Figueiredo, Amora (PT); Yunsong Wang, Shanghai (CN); Arnold J D'Souza, Bangalore (IN); Shyam Somayajula, Bangalore (IN)

(21) Appl. No.: 18/916,769

(22) Filed: Oct. 16, 2024

(30) Foreign Application Priority Data
Nov. 15, 2023 (IN) 202341077645

(51) Int. Cl. H02M 3/158; G01K 3/00; G01K 7/00; H02M 1/00; H02M 1/08

(52) U.S. Cl. CPC H02M 3/1584; G01K 3/005; G01K 7/00; H02M 1/0009; H02M 1/08

(57) ABSTRACT

A power stage of multi-phase switching converter includes a pair of power switches, a temperature sensor, a comparator and a current-sense block. The power switches are operated to be on or off by a phase controller of the converter to drive an inductor-current through an inductor. The temperature sensor generates a temperature signal indicative of the temperature of the power stage. The temperature signal is coupled to be indicated on a common path which indicates to the phase controller a first temperature derived from all of the temperature signals from all the operating power stages of the converter. A comparator compares magnitudes of the temperature signal and the first temperature. If the result indicates that the magnitudes are unequal, the current-sense block reports, to the phase controller, a first magnitude in variance with an actual magnitude of the inductor-current to cause the temperature to tend towards the first temperature.

### PRIORITY CLAIM

The instant patent application is related to and claims priority from the provisional India patent application entitled, “SPS Dynamic Thermal Balancing”, Serial No.: 202341077645, Filed: 15 Nov. 2023; Attorney docket no.: AURA-349-INPR, which is incorporated in its entirety herewith to the extent not inconsistent with the description herein.

### BACKGROUND

### Technical Field

Embodiments of the present disclosure relate generally to power supply circuits, and more specifically to balancing temperatures of power stages of a multi-phase switching converter.

### Related Art

A switching converter refers to a component which generates a regulated DC (direct current) voltage from an input power source by employing one or more switches, as is well known in the relevant arts. Typically, a switching converter transforms the voltage (input supply voltage) of the input power source into a pulsed voltage by operating switch(es), the pulsed voltage then being smoothed using capacitors, inductors, and other elements to generate the regulated DC voltage. Power is supplied from the input to the output by turning ON and OFF switches (e.g., MOSFETs) to generate and regulate the desired voltage.

Switching converters are used in components such as regulated power supplies, which in turn are used in devices such as computers and mobile phones, as is also well known in the relevant arts.

A switching converter often contains a pair of power switches driving an inductor. Each power switch (switch) is typically implemented as a transistor (e.g., MOSFET) and the switches are connected in series between input supply voltage and a reference terminal (e.g., ground). The switch coupled closer to the input voltage (source of input power to the converter) is termed as the high-side switch, while the other one is termed as a low-side switch. The switches are operated by a control circuit which switches ON the transistors in successive non-overlapping time durations to cause the switch that is currently ON to drive the inductor in the corresponding duration.

A multi-phase switching converter contains multiple ones of such pairs of switches, along with associated circuitry for each pair. Each pair is typically operated in a corresponding phase of a sequence of phases, with the pairs together operating to generate the desired regulated voltage (supply rail) and capable of supporting higher load currents at greater efficiencies as well as providing other advantages, as is well known in the relevant arts. Each of such pairs, along with the associated circuitry, is referred to as a power stage of a supply rail provided by the multi-phase switching converter. A phase controller operates to control the specific times that each of the power stages of a supply rail is operative in generating the desired output voltage.

It is generally desirable that all the power stages of a rail operate at substantially the same temperature. However, one or more factors can cause the temperatures of the power stages to be (substantially) unequal. Therefore, it may be desirable to balance the temperatures of the power stages. Balancing generally refers to equalizing the temperatures of the operating power stages or bringing the temperatures of the operating power stages within a desired variance band, such as for example, a maximum temperature variance of 5% among all the operating power stages.

Several aspects of the present disclosure are directed to balancing temperatures of power stages of a multi-phase switching converter.

### BRIEF DESCRIPTION OF THE VIEWS OF DRAWINGS

Example embodiments of the present disclosure will be described with reference to the accompanying drawings briefly described below.

FIG. 1 is a block diagram of an example system in which several aspects of the present disclosure can be implemented.

FIG. 2 is a block diagram illustrating the details of a voltage regulation module (VRM) in an embodiment of the present disclosure.

FIG. 3 is a diagram illustrating the implementation details of relevant portions of a temperature monitor block according to a prior technique.

FIG. 4 is a diagram illustrating the implementation details of a power stage in an embodiment of the present disclosure.

FIG. 5 is a diagram illustrating the implementation details of a temperature monitor of a power stage in an embodiment of the present disclosure.

FIG. 6 is a diagram illustrating an example implementation of a portion of a current-sense block of a power stage in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

A power stage provided according to several aspects of the present disclosure is one of multiple power stages that together generate a supply voltage on a power rail of a multi-phase switching converter. A phase controller of the multi-phase switching converter controls operation of the multiple power stages. The power stage includes a high-side power switch and a low-side power switch to respectively drive an inductor in a first interval and a second interval periodically based on a control signal received from the phase controller. An actual magnitude of current flowing though the inductor is determined by ON durations of the high-side switch and the low-side switch as set by the control signal.

The power stage further contains a temperature sensor, a comparator and a current-sense block. The temperature sensor generates a temperature signal indicative of the temperature of the power stage. The temperature has a positive correlation with the actual magnitude of the current through the inductor. The temperature signal is coupled to be indicated on a common path, which indicates to the phase controller a first temperature derived from all of the temperature signals provided by the multiple power stages.

The comparator generates a comparison result of a comparison of magnitudes of the temperature signal and the first temperature. The current-sense block provides information representing a first magnitude of the current flowing through the inductor to the phase controller. The phase controller sets the ON durations of the two power switches based on the first magnitude.

According to an aspect of the present disclosure, if the comparison result indicates that the magnitudes are unequal, the current sense block reports the first magnitude to be in variance with the actual magnitude to cause the temperature of the power stage to tend towards the first temperature.

In an embodiment, the first temperature is a maximum temperature of those generated by each of the multiple power stages. If the temperature represented by the temperature signal is less than that represented by the signal on the common path, the current-sense block reports the first magnitude to be less than the actual magnitude.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example System

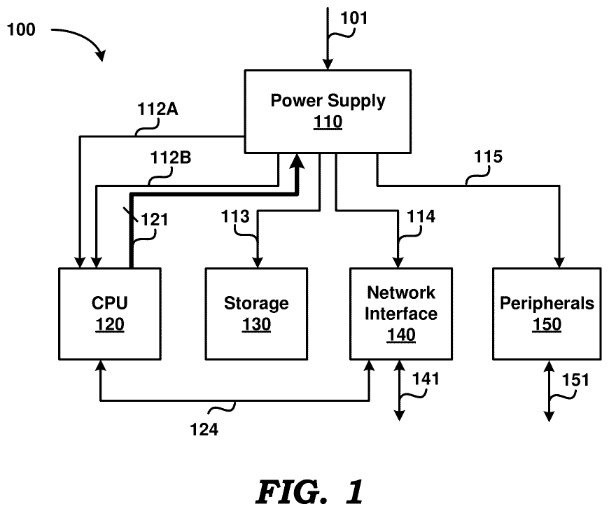

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a smaller voltage than Vb, and may be used to power a core portion of CPU which may include arithmetic logic unit (ALU), microprogram sequencer, registers, etc. Vb may be used to power the rest of CPU 120, such as for example, input/output (I/O) units, I/O buffers, on-chip peripherals etc. CPU 120 provides various signals (all deemed to be contained in path 121) specifying, among others, its power supply requirements to power supply 110. Examples of such signals can be those that specify the specific mode of operation (in terms of power consumption) such as PS1, PS2, PS3, etc., which refer to “Power Save States for Improved Efficiency”.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provided two-way communication between system 100 and a computer network, or in general the Internet. Network interface 140 implements the electronic circuitry required to communicate using a specific physical layer and data link layer standard such as Ethernet or Wi-Fi™. Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 receives from/transmits to external systems and CPU 120 respectively on path 141 and path 124.

Peripherals 150 represents one or more peripheral circuits, such as for example, speakers, microphones, user interface devices, etc. Peripherals 150 receives a power supply on path 115, and communicates with external devices on path 151.

Power supply 110 receives power from one or more sources (e.g., battery) on path 101, and operates to provide the desired power supply voltages on paths 112A, 112B, 113, 114 and 115. In an embodiment, power supply 110 is designed to contain one or more multi-phase DC-DC converters within to generate the power supply voltages. Power supply 110 receives signals from CPU 120 received on path 121 that may indicate power-modes in which CPU 120 is to operate in a particular duration, with the power-modes representing a magnitude of power that CPU 120 is likely to require/consume from power supply 110. Power supply 110 responds to the signals by controlling the multi-phase converter(s) to reduce/increase current output based on the specific power-mode signal (e.g., PS1, PS2 and PS3).

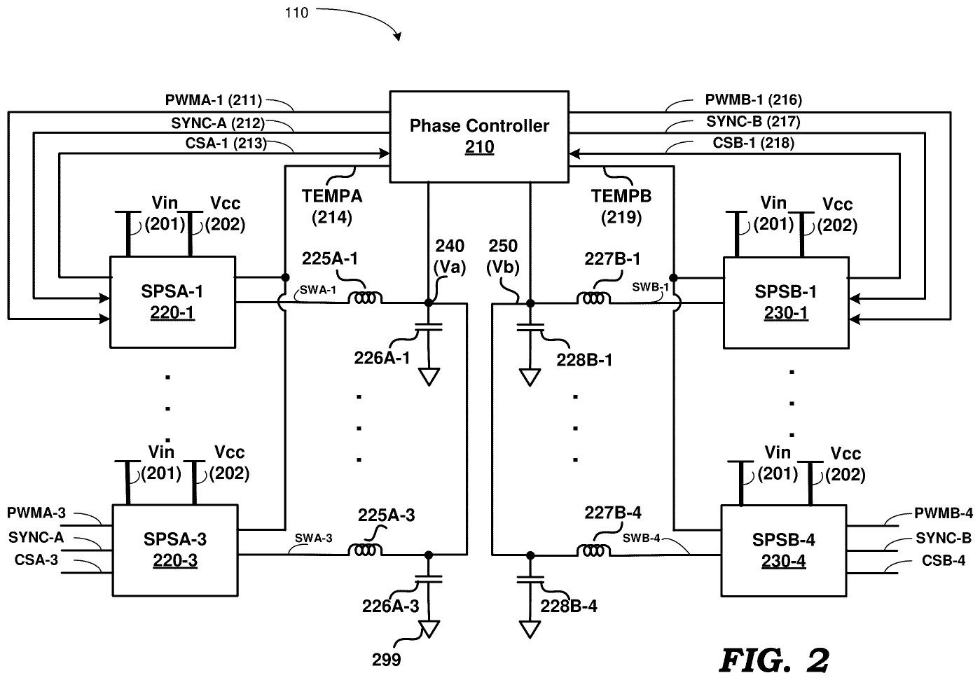

In an embodiment, power supply 110 is a voltage regulator module (VRM), sometimes also called processor power module (PPM), and contains one or more step-down switching (buck) converters to generate one or more smaller voltages from a higher-voltage supply source. In other embodiments however, other types of DC-DC converters such as boost, buck-boost, hysteretic converters etc., can be implemented instead of a buck converter. With a VRM, multiple devices/ICs requiring different supply voltages can be mounted on the same platform, for example, a computer motherboard of a personal computer (PC). Accordingly, the description is continued with respect to a VRM as shown in FIG. 2.

### 3. Voltage Regulator Module (VRM)

FIG. 2 is a block diagram illustrating the details of a VRM in an embodiment of the present disclosure. Power Supply 110 (of FIG. 1) is a Voltage Regulator Module implemented in the form of a multi-phase switching converter generating two regulated voltages, i.e., two supply rails (power rails), namely Va (240) (Rail-A) and Vb (250) (Rail-B). Nodes 240 and 250 may respectively be also viewed as the power rails. In FIG. 2, the supply source used for deriving Va and Vb is shown numbered 201, and has a voltage Vin. An example value of Vin in an embodiment of VRM 110 is about 21 volts (V). Also shown is a supply voltage Vcc (202), which may be provided by phase controller 210, and which may be used for powering the blocks within each power stage noted below.

VRM 110 is shown containing phase controller 210, smart power stages (SPS) (or ‘power stages’) SPSA-1 (220-1) through SPSA-3 (220-3), SPSB-1 (230-1) through SPSB-4 (230-4), inductors 225A-1 through 225A-3 and 227B-1 through 227B-4 and capacitors 226A-1 through 226A-3 and 228B-1 through 228B-4. Power supply Va (240) (Rail-A) is generated by a 3-phase buck converter (there are three SPSes —220-1 through 220-3), while power supply Vb (250) (Rail-B) is generated by a 4-phase buck converter (there are four SPSes —230-1 through 230-4). Nodes/Paths 240 and 250 can correspond to paths 112A and 112B of FIG. 1. In the interest of conciseness, other power supply circuits that generate supplies on paths 113, 114 and 115 are not shown in FIG. 2. In alternative embodiments, VRM 110 can have more or fewer power rails as well as power stages per rail.

In an embodiment of the present disclosure, each of the power stages as well as the phase controller is implemented as separate integrated circuits (ICs). However, in other embodiments, the implementations of the power stages and phase controller may be different.

Phase controller 210 in conjunction with one or more power stages of a rail operates to generate a regulated voltage as output. In the example of FIG. 2, phase controller 210 in combination with one or more of power stages SPSA-1 through SPSA-3 operates to generate regulated voltage Va (240). Similarly, phase controller 210 in combination with one or more of power stages SPSB-1 through SPSB-4 operates to generate regulated voltage Vb (250). Accordingly, Va (240) and Vb (250) are shown as being provided as inputs to phase controller 210 to enable operation of one or more feedback loops within phase controller 210 to regulate voltages Va and Vb. Phase controller 210 also receives inductor-current information (regarding current flowing through each of the inductors) from each of the SPSes to enable various operations such as current-mode control of voltage regulation, current limiting, short circuit protection, and balancing the currents generated by each SPS of a same converter (or ‘rail’) so as to make the currents from each SPS of a rail to be substantially equal in magnitude. The other signals flowing between phase controller 210 and the SPSes are described below.

The combination of (corresponding circuitry within) phase controller 210, an SPS and the corresponding inductor and capacitor forms one “phase” of a rail. Thus, for example, SPSA-1, inductor 225A-1, capacitor 226A-1, and the corresponding portion within phase controller 210 form a single buck converter, and one phase of the 3-phase buck converter. It is noted here that, while each phase is shown as having its own separate capacitor (e.g., 226A-1), in another embodiment, only a single larger capacitor (larger capacitance) may be employed at node 240 (as well as 250). In other embodiments, multiple capacitors are placed close to the load powered by the corresponding supply voltage. For simplicity, an individual SPS is also referred to as a phase of a power-rail.

Each SPS (or in general a ‘power stage’) may be implemented to contain a high-side switch, a low-side switch, gate-drive circuitry for the two switches, a temperature monitor circuit and an inductor-current-sense circuit/block to provide information indicating the magnitude of inductor-current to phase controller 210. The current supplied by an SPS, and therefore the corresponding inductor-current generally depends on the load current drawn from the supply voltage, although the high-side switch and low-side switch of an SPS may be viewed as ‘driving’ the inductor. Each SPS receives a source of power (which can all be the same source) as an input which is connected to the high-side switch (shown in detail in sections below).

Each SPS communicates with phase controller 210 via corresponding signals PWM, SYNC, CS and TMP. Thus, SPSA-1 is shown connected to phase controller 210 through signal/paths PWMA-1 (211), SYNC-A (212), CSA-1 (213) and TEMPA (214). SPSA-6 communicates with phase controller 210 via signals PWMA-6, SYNC-A, CSA-6 and TEMPA (214), although in FIG. 2, the respective connections of signals PWMA-6, SYNC-A and CSA-6 to phase controller 210 are not shown. Similarly, SPSB-1 is shown connected to phase controller 210 through signal/paths PWMB-1 (216), SYNC-B (217), CSB-1 (218) and TEMPB (219). SPSB-3 communicates with phase controller 210 via signals PWMB-3, SYNC-B, CSB-3 and TEMPB (219), although in FIG. 2, the respective connections of signals PWMB-3, SYNC-A and CSB-3 to phase controller 210 are not shown. The other SPSes would have similar connections with phase controller 210. In general, each SPS has a PWM, SYNC, CS and TEMP pin for the corresponding connections noted above when implemented as an IC, and the corresponding signals to/from a power stage from/to phase controller 210 may be generally referred to as the PWM, SYNC, CS and TEMP signal corresponding to that power stage.

Signal PWM is an input to an SPS from phase controller 210 and represents a pulse-width modulated (PWM) signal. A PWM signal may be generated to have a logic HIGH state, a logic LOW state or a high-impedance (Hi-Z) state. Typically, the logic HIGH and logic LOW states of the PWM signal correspond respectively to the voltages (within error/noise margins) of the positive and negative rails of the power supply of the circuit generating the PWM signal, and the Hi-Z state corresponds to the mid-rail voltage of the power supply (or a voltage-window around the mid-rail voltage), as is well known in the relevant arts. However, other conventions can be employed for the three states of the PWM signal as would be apparent to one skilled in the relevant arts.

The PWM signal controls the opening and closing of high-side switch and low-side switch of a phase/power stage via the logic HIGH and logic LOW states. Typically, the logic HIGH state is used to switch ON (i.e., close) the high-side switch and switch OFF (i.e., open) the low-side switch (the corresponding duration may be referred as the ‘first interval’), while the logic LOW state is used to switch ON the low-side switch and switch OFF the high-side switch (the corresponding duration may be referred as the ‘second interval’). Each cycle of the PWM signal has corresponding a ‘first interval’ and a ‘second interval’.

The Hi-Z state of the PWM signal indicates to the power stage that the power stage is not to operate in generating the output voltage, i.e., be ‘inactive’. Thus, when PWM is in the Hi-Z state, both the high-side and low-side switches of the stage are OFF, and the power stage can go to low-power/power-down modes. In general, phase controller 210 is designed to generate the PWM signal in a manner capable of indicating three states, with one of the three states indicating that the corresponding power stage is to be inactive. It will be apparent to one skilled in the relevant arts that such tri-state capability can be implemented in other ways. As an example, phase controller 210 can be implemented to generate PWM as a conventional binary signal with the power stages implemented to identify a Hi-Z state if the PWM signal is turned OFF, i.e., not generated at all.

The duty cycle of the PWM signal is set by phase controller 210 and is designed to generate the desired power supply voltage and/or control/change the current supplied by that phase. For example, PWMA-1 would have a duty cycle as required for the magnitude of Va and the current to be provided by SPSA-1. The magnitude of current flowing through the inductor corresponding to a power stage is determined by ON durations of the high-side switch and the low-side switch of that stage, and is set by the stage's PWM input (or control signal in general).

As is well known in the relevant arts, the PWM signals to each SPS of a same converter may be staggered, i.e., delayed with respect to each other in phase such that typically no two high-side switches of a rail (i.e., in respective SPSes) are ON at the same time. Such a technique is employed for reasons such as, for example, to ensure that the peak instantaneous current drawn from Vin is relatively low at all times.

Signal SYNC is an input to an SPS and may be used by phase controller 210 for the purposes of waking-up the SPS upon power-up of the power supply 110, and also to indicate the power-mode (e.g., PS2, PS3), i.e., output current requirement, of the multi-phase converter. Typically, all SPSes of the same converter share a single SYNC signal (e.g., SYNC-A 212).

Signal CS (current-sense) is an input to phase controller 210 from an SPS/phase, and contains information regarding the magnitude of the inductor-current of that phase. The information can be in the form of a current, voltage, digital values, etc., depending on the specific implementation of the power stages and phase controller 210. A CS block in an SPS implements the current-sense operation and sends signal CS to phase controller 210.

In an embodiment of the present disclosure, the current-sense block of a power stage sends the sensed inductor-current information to phase controller 210 in the form of a current that can be of either the same magnitude as the inductor-current or (more typically) be a scaled-down version (in terms of magnitude) of the inductor-current. Correspondingly, in the embodiment, phase controller 210 is designed to receive the information in the form of a current, with the scaling factor being known to phase controller 210 as well as the (corresponding) power stage when scaling is used.

The TEMP pins (or nodes) of all the stages of a rail are wired together, and only a single TEMP input is provided to phase controller 210, as may be observed from FIG. 2. For example, corresponding to rail-B, a single connection TEMPB (219) is provided to phase controller 210 based on the temperatures reported by each power stage of rail-B. Such an approach is usually adopted to minimize the number of wires/PCB (printed circuit board) tracks (and therefore signals) from the power stages of a rail to phase controller 210, as well as to reduce the pinout (number of pins) of phase controller 210. The temperature of a power stage is proportional (has a positive correlation with) the magnitude of the inductor-current of the power stage.

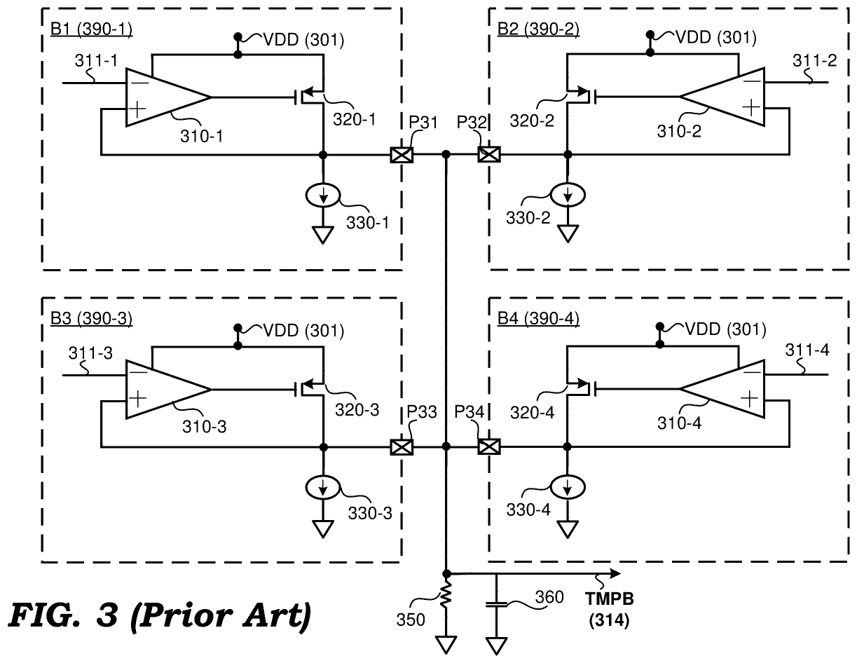

In a prior implementation, power stages are designed in a manner such that the single TEMP input provided to phase controller 210 automatically (by operation of the corresponding circuits) takes a value that is the maximum of the temperatures recorded in each power stage. FIG. 3 shows the circuit details of the relevant portions of a temperature monitor block according to the prior technique. In FIG. 3, four power stages of rail-B according to the prior implementation are shown. The four prior stages are labelled B1 (390-1), B2 (390-2), B3 (390-3) and B4 (390-4). The output pins P31, P32, P33 and P34 of the respective power stages are all connected and the common connection/path is provided to the phase controller as TMPB (314). TMPB (314) corresponds to the common path TEMPB (219) of FIG. 2. The common path TMPB (314) is shown terminated with resistor 350 (about 50 kilo ohms) and capacitor 360 (about 10 nano Farads).

Power stage B1 is shown containing amplifier 310-1, P-channel MOSFET (metal oxide semiconductor field effect transistor) (or ‘PMOS’) 320-1 and current sink 330-1. Power stage B1 additionally contains a temperature sensor (not shown) that generates a voltage (temperature signal) on path 311-1 that is indicative of the sensed temperature of B1. When implemented as an integrated circuit (IC), the temperature sensor is implemented to sense the temperature of the semiconductor die of B1. In alternative implementations of B1, such as for example using discrete components, the temperature sensor may be designed to sense the temperature at, or near, the power switches of B1. Other approaches suitable to the specific implementation of B1 can also be used. Amplifier 310-1 receives the voltage on path 311-1 on its inverting (−) terminal and the voltage on the ‘temperature-reporting’ output pin P31 on its non-inverting (+) terminal. The output of amplifier 310-1 is connected to the gate terminal of PMOS 320-1. Current sink 330-1 may be implemented as a weak pull-down (5 micro-amperes). VDD (301) represents a power supply terminal received from an external source such as phase controller 210.

Amplifier 310-1, PMOS 320-1 and current sink 330-1 together operate to ‘drive’ the voltage (representing the sensed temperature) received on path 311-1 onto output pin P31, and therefore the combination of amplifier 310-1, PMOS 320-1 and current sink 330-1 may be viewed as a ‘driver circuit’. The respective circuits of the other three power stages may also be viewed as corresponding driver circuits.

If pin P31 were disconnected from common path TMPB (314), then the voltage on pin P31 equals that of the temperature signal 311-1. In other words, the temperature signal is forwarded as-is (without any change) on temperature-reporting pin P31.

However, with pin P31 (as well as pins P32, P33 and P34) connected to common path TMPB (314), the voltage on common path TMPB (314) equals the maximum (the highest in magnitude) of the four temperature signals 311-1, 311-2, 311-3 and 311-4, due to the operation of the respective driver circuits. With reference to the driver circuit of B1 as shown in FIG. 3, if the voltage on the non-inverting terminal (which is same as the TMPB (314) path) is greater than that on path 311-1, then the output of amplifier 310-1 is high enough to switch-OFF PMOS 320-1. If the voltage on TMPB (314) is less than or equal to that on the inverting terminal, the output of amplifier 310-1 will have an output voltage that causes PMOS 320-1 to be ON with a resistance such that the voltage on the non-inverting terminal becomes equal to that on path 311-1.

The other three stages B2-B4 have similar circuitry as in B1 and also operate in a similar manner. Thus, paths 311-2, 311-3 and 311-4 correspond to path 311-1 and respectively receive the voltage output generated by a corresponding temperature sensor in the corresponding stage. Similarly, amplifiers 310-2, 310-3 and 310-4 correspond to amplifier 310-1, PMOS transistors 320-2, 320-3 and 320-4 correspond to PMOS 320-1, and current sinks 330-2, 330-3 and 330-4 correspond to current sink 330-1.

The effect of the combined operation of the circuitry shown in FIG. 3 is such that the maximum of the voltages output by the respective temperature sensors (on respective paths 311-1 to 311-4) appears on TMPB (314).

In general, the prior power stages noted above can be designed with circuitry such that the temperature signal generated on the common path (TMPB 314 in the example of FIG. 3) is derived from (e.g., be some mathematical function of) all of the temperature signals (311-1 through 311-4 in the example of FIG. 3) generated in each operating power stage. In the illustration of FIG. 3, the derived signal is a ‘maximum’ of the individual signals. In other implementations, the derived signal can be of a different type. As another example, the derived signal on the common path can be an average of the individual temperature signals.

As noted above, one or more factors can cause the power stages of a rail to have different operating temperatures. For example, there could be current mismatches among the power stages even if the power stages are all operated by the phase controller to provide the same current. Another factor can be that the power stages may be physically located on the PCB such that one or more of the power stages operate in different ambient temperatures (example, those closer to a processor may have a higher ambient temperature), causing their temperatures also to be different.

One drawback with the use of a single common path is that phase controller 210 obtains only the derived signal (e.g., the maximum of the individual temperature signals). Therefore, phase controller 210 may not be able to balance the temperature of the power stages, and be limited to actions such as, for example, forcing all the power stages to reduce their inductor-currents if the maximum temperature indicated on the common path exceeds a safe upper limit. Alternatively, the phase controller can switch-OFF all the power stages of the rail if the maximum temperature exceeds the safe upper limit. As a result, VRM 110 may operate at a reduced performance level, and may be able to support only lower power-modes of CPU 120.

Embodiments of the present disclosure are designed to overcome the problems noted above as described next.

### 4. Power Stage (SPS)

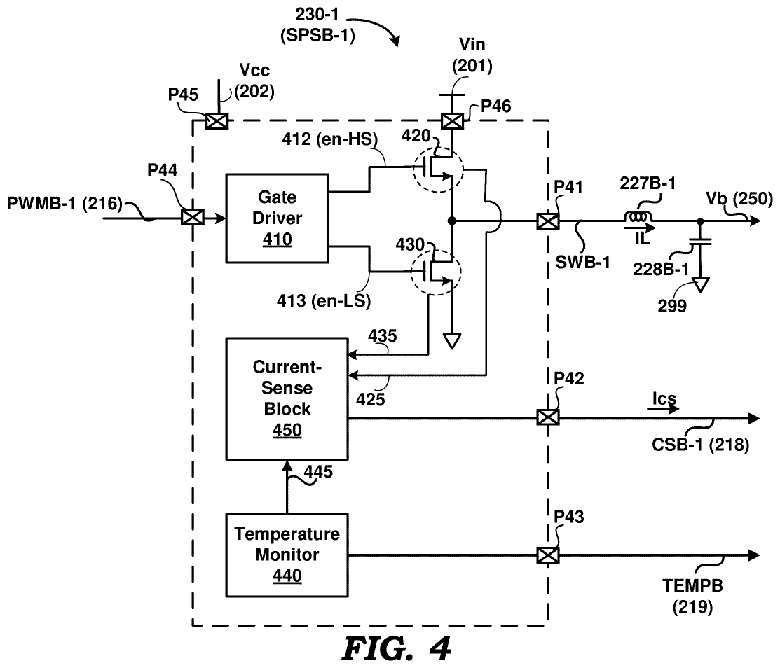

FIG. 4 is a diagram illustrating the implementation details of a power stage in an embodiment of the present disclosure. Power stage 230-1 (SPSB-1) of FIG. 2 is shown in FIG. 4 containing gate driver 410, high-side (HS) switch 420, low-side (LS) switch 430, temperature monitor 440 and current-sense block 450. Also shown in FIG. 4 are inductor 227B-1 and capacitor 228B-1 corresponding to the power stage. P41 through P46 represent pins of SPSB-1 when implemented as an IC. Current ‘IL” represents the inductor-current flowing through inductor 227B-1 and current “Ics” represents the sensed inductor-current reported by power stage 230-1 on output pin P42 which is connected to phase controller 210 via path CSB-1 (218). Vcc (202) is used to power blocks 410, 440 and 450. The drain terminal of HS switch 420 is connected to Vin (201).

Power stage 230-1, in combination with inductor 325 and capacitor 326 and phase controller 210 provides a regulated voltage (Vb) as output on node 250. Although not shown in FIG. 3 in the interest of conciseness, power stage 300 may contain various other blocks/circuits such as a level-converters for gate driver 410, etc. Pins/circuits in power stage 230-1 that are connected to process a SYNC input signal are not shown in the interest of conciseness.

All the other power stages of FIG. 2 (of rail-B and optionally of rail-A also) are implemented similar to that of power stage 230-1 of FIG. 4 and as further described below.

Gate driver 410 receives a PWM signal PWMB-1 (216) (from phase controller 210), and in response to the logic level of the PWM signal generates the appropriate voltages to turn ON and turn OFF HS switch 420 and LS switch 430 in corresponding intervals indicated by the logic levels of the PWM signal. HS switch 420 and LS switch 430 are each shown implemented as an N-channel MOSFET (Metal Oxide Semiconductor Field Effect Transistor) with gate driver 410 driving the gate terminals of the MOSFETs. Other implementations for the switches are also possible. In the example of FIG. 4, when the PWMB-1 is a logic HIGH, gate driver 410 generates respective appropriate voltages on paths 412 (en-HS) and 413 (en-LS) to switch-ON MOSFET 420 and switch-OFF MOSFET 430. When PWMB-1 is a logic LOW, gate driver 410 generates respective appropriate voltages on paths 412 and 413 to switch-OFF MOSFET 420 and switch-ON MOSFET 430. When PWMB-1 is a Hi-Z (High-impedance or mid-rail) state, gate driver 310 generates the respective appropriate voltages on paths 412 and 413 to switch-OFF both of MOSFET 420 and 430. Gate driver 410 can be implemented in a known way.

Current-sense block 450 operates to determine the magnitude (for example, instantaneous magnitude) of the inductor-current through inductor 227B-1, and provides information indicating the inductor-current magnitude on output pin P42, which is connected to phase controller 210 by path CSB-1 (218). Current-sense block 450 may determine the magnitude of the inductor-current by one of several known ways. For example, in FIG. 4 current-sense block 450 is shown as receiving inputs 425 and 435 respectively from HS switch 420 and LS switch 430. In an embodiment, signals 425 and 435 represent the respective voltage-drops across the HS and LS switches when the corresponding switch is ON and current is flowing through it and inductor 227B-1. Current-sense block 450 obtains the instantaneous magnitude of the inductor-current (or a scaled-down version thereof) based on the voltage-drops. In another embodiment current-sense block 450 employs sensing of the voltage-drop across the LS switch 430 for directly obtaining the inductor-current magnitude (or a scaled-down version thereof) when the LS switch is ON, and ‘constructs’ (or emulates) the inductor-current magnitude when the HS switch 420 is ON.

In an embodiment, current-sense block 450 provides/reports the inductor-current information in the form of a (replica) current (indicated as Ics) having a magnitude that is scaled-down with respect to the instantaneous inductor-current magnitude. However, in alternative embodiments, current-sense block 450 can be implemented to provide the information in the form of a voltage or a digital value(s). Current-sense block 450 receives an input signal 445 from temperature monitor 440 as described below.

Temperature monitor 440 contains a temperature sensor within it that generates a ‘temperature’ signal (e.g., in the form of a voltage) that indicates the temperature of power stage 230-1 (e.g., the die temperature). An example relation between the temperature and the voltage generated by the temperature sensor, or in other words the ‘gain’ of the temperature sensor, is 10 milli Volts (mV) per degree centigrade (C), i.e., 10 mV/C. However, other relations can be employed.

Temperature monitor 440 contains a circuit (driver circuit) that receives the temperature signal from the temperature sensor and drives the temperature signal onto output pin P43 in a manner such that when P43 is connected to common path TEMP (219) (which would be also connected to corresponding output pins of the other power stages of the same rail, namely SPSB-2 through SPSB-4), the signal on the common path TEMP (219) automatically acquires a magnitude that is derived from (is some desired function of) all of the temperature signals of the respective power stages SPSB-1 through SPSB-4. In an embodiment of the present disclosure, the derived magnitude is the maximum of all the temperature signals of the respective power stages. Thus, signal on common path TEMPB (219) represents the maximum of the individual temperatures of the respective power stages. However, it is noted here (and described further below) that in alternative embodiments, the driver circuit can be implemented differently such that the derived magnitude is some other function (e.g., average) of all the temperature signals.

According to an aspect of the present disclosure, temperature monitor 440 compares the magnitudes of the temperature signal generated by the temperature sensor within it with that of the signal on the common path TEMPB (219). Temperature monitor 440 transmits the result of the comparison on path 445 to current-sense block 450. If the result of comparison indicates that temperature signal is less than signal TEMPB (219) by a predetermined value (which itself can be zero or non-zero, such as for example 2.4 mV in an embodiment), then current-sense block 450 under-reports the actual inductor-current magnitude to phase controller 210 via path CSB-1 (218). In other words, the sensed-current information generated by current-sense block 450 on path CSB-1 (218) is deliberately reported as having a smaller magnitude than that it would otherwise be (if the two magnitudes were equal or within a predetermined range, such as for example +/−2.4 mV, of each other).

As a result, phase controller 210 generates PWMB-1 (216) in a manner so as to cause power stage SPSB-1 to increase its inductor-current thereby pushing the temperature of power stage SPSB-1 towards the temperature indicated by the signal on TEMPB (219). Additionally, or alternatively, phase controller 210 generates the respective PWM signals provided to the other power stages, namely SPSB-2, SPSB-3 and SPSB-4, in a manner so as to cause those power stages to either decrease or increase the respective inductor-currents (depending on the corresponding sensed inductor-currents reported by them), thereby pushing the temperatures of all the four power stages towards equality.

The specific magnitude by which current-sense block 450 under-reports its sensed inductor-current may be predetermined by design in current-sense block 450 based, for example, on the specific operating requirements/environment of the circuits/ICs of rail-B and VRM 110 in general. Similarly, the extent by which phase controller 210 causes the inductor-currents of one or more of the power stages to be increased or decreased may be predetermined based, for example, on similar considerations.

An example temperature imbalance that may be corrected by a power stage is briefly noted next. An increase in inductor-current of one Ampere (1 A) may increase the temperature of the power stage by 1.5 degrees Centigrade (C) at a package (IC package) thermal resistance of 10 C/W. To correct a temperature imbalance of 7.5 C, i.e., to increase the temperature of the power stage by 7.5 C the inductor-current needs to be increased by 7.5 A. The under-reporting noted above may be correspondingly determined.

In an embodiment, current-sense block 450 is designed to under-report Ics (sensed inductor-current) by 10 micro-Amperes (uA) if inductor-current of stage SPSB-1 is to be increased by 1 A, and the minimum value (resolution) by which current-sense block 450 can under-report Ics is set to 1 uA.

It is noted here that thermal feedback is typically very slow. That is, when a change in inductor-current is made, a corresponding change in temperature of the corresponding power stage may take several milliseconds. Hence, any updates by signal 445 may need to be very small and only at a maximum rate of the order of, for example, once every millisecond (ms).

Due to the under-reporting by current-sense block 450, the current-balance loop (the loop that operates to maintain the inductor-currents of all the power stages of a rail to be substantially equal) operative within phase controller 210 would generate PWMB-1 with a larger duty-cycle (to cause HS switch 420 to be ON for longer in each PWM cycle) thereby resulting in a larger inductor-current for SPSB-1. This, in turn, would increase the temperature of power stage SPSB-1 until it becomes equal (or at least substantially equal) to that indicated by the signal on path TEMPB (219). Additionally, or alternatively, the current-balance loop in phase controller 210 may generate the respective PWM signals provided to the other power stages, namely SPSB-2, SPSB-3 and SPSB-4 with relatively shorter duty-cycles to cause those power stages to decrease or increase their respective inductor-currents.

As a result, eventually the temperatures of all the four power stages would become balanced.

With all the power stages SPSB-1 through SPSB-4 implemented and operative as described above, the temperatures of the power stages would be balanced. It is noted here that some degree of temperature balance may be obtained even if not all of the four power stages, but only a subset, operate as described above.

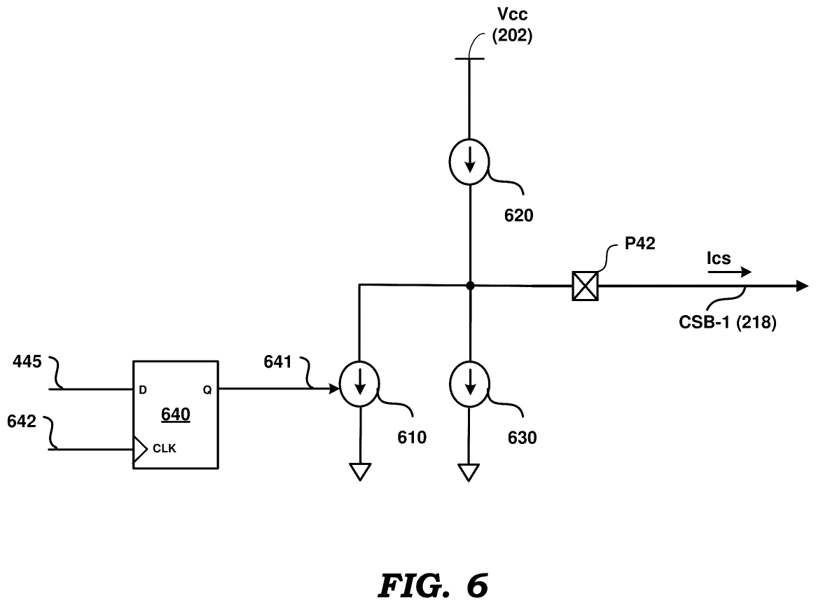

The portion/circuit of current-sense block 450 that causes current-sense block 450 to operate as described above in response to the signal received on path 445 is described below with reference to FIG. 6.

The implementation details of temperature monitor 440 in an embodiment of the present disclosure are provided next.

### 5. Temperature Monitor

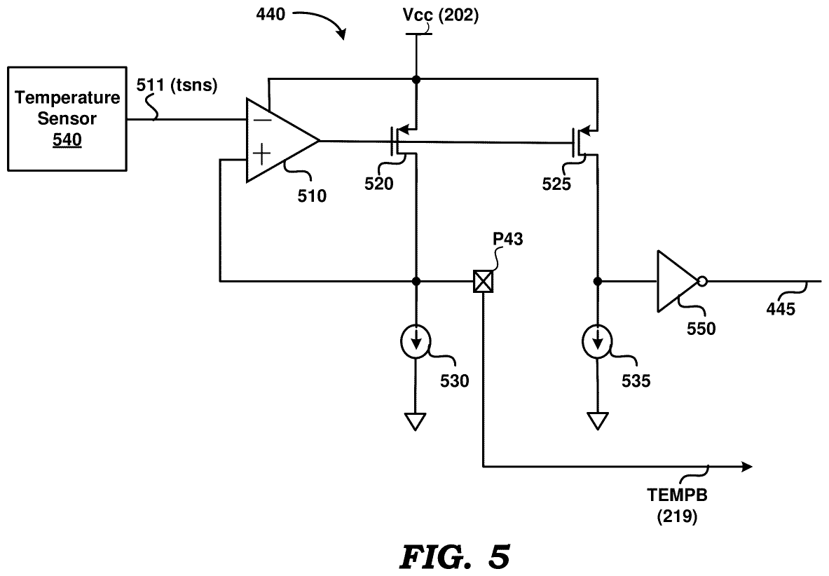

FIG. 5 is a diagram illustrating the implementation details of temperature monitor 440 in an embodiment of the present disclosure. Temperature monitor 450 is shown containing temperature sensor 540, amplifier 510, PMOS 520 and 525, current sinks 530 and 535 and inverter 550. The gate terminal of each PMOS is connected to the output of amplifier 510, and the source terminal of each PMOS is connected to Vcc (202). Components PMOS 525, current sink 535 and inverter 550 together constitute a ‘current comparator’. Current sinks 530 and 535 may be designed to operate as weak pull-downs. The specific implementation details of temperature monitor 440 are shown and described merely by way of illustration. Other ways to implement temperature monitor 440 would be apparent to those skilled in the relevant arts upon reading the disclosure herein.

Temperature sensor 540 generates a voltage ‘tsns’ that represents the sensed temperature of power stage SPSB-1. When implemented as an integrated circuit (IC), temperature sensor 540 senses the temperature of the semiconductor die of power stage SPSB-1. In alternative implementations, such as for example those using discrete components, temperature sensor 540 may be designed to sense the temperature at, or near, the power switches 420 and 430. Other approaches suitable to the specific implementation of SPSB-1 can also be used.

Amplifier 510, PMOS 520 and current sink 530 may together be viewed as a ‘driver circuit’ that operates to ‘drive’ ‘tsns’ onto output pin P43 in a manner similar to that described above with respect to power stage B1 of FIG. 3.

The current comparator generates a logic HIGH output on path 445 if voltage TEMPB (219) is greater than voltage ‘tsns’ by a pre-determined amount (as noted above), and a logic LOW otherwise. Signal 445 causes current sense block 450 (FIG. 4) to operate as noted above. FIG. 6 is a diagram illustrating an example implementation of the portion of current-sense block 450 (FIG. 4) to cause such operation in an embodiment of the present disclosure and is described briefly next.

FIG. 6 is shown containing controllable current source 620, current sinks 610 and 630, and flip-flop (FF) 640. The currents generated by current sources 620 and 630 are controlled by respective outputs of a differential-output amplifier (not shown), with the input (which may also be differential) of the amplifier receiving the voltage drop across the HS switch 420 when PWMB-1 is high and the voltage drop across the LS switch when PWMB-1 is low. The differential voltage output of the amplifier controls the current generated by current source 620 and current sink 630 in a manner such that the voltage of one of the pair of outputs controls the current generated by current source 620, and the voltage on the other one of the pair of outputs controls the current generated by current sink 630. As the voltage drop across the input of the amplifier increases, the current generated by 620 is correspondingly larger than that generated by current source 630. The difference of the two currents flows into pin P52 and onto path CSB-1 (218) as Ics. The control of current source 620 and current sink 630 can be implemented in a known way. For an example technique, the reader is referred to the description of FIG. 4 of US patent application publication number: US 2024/0030811, entitled “EMULATING CURRENT FLOWING THROUGH AN INDUCTOR DRIVEN BY A COMBINATION OF HIGH-SIDE SWITCH AND A LOW-SIDE SWITCH IN A SWITCHING CONVERTER, which is incorporated herein by reference. Transistor 420 and 421 of FIG. 4 of the above noted publication correspond to current source 620 and current sink 630. Although, in the publication the high-side switch current is emulated, it can instead also be sensed by obtaining the voltage-drop across the HS switch as noted above, and FIG. 4 of the publication can be accordingly modified in a known way.

FF 640 receive signal 445 on its D input, and transfers the logic value of signal 445 to its Q output at every rising edge of clock 642, which in an embodiment is generated internally in power stage SPSB-1 with a period of one millisecond (1 ms). When signal 445 is a logic HIGH, Q output 641 becomes a logic HIGH and switches-ON current sink 610. As a result, current sink 610 sinks a fixed current (e.g., of the order of 1 to 10 micro amperes) from pin P62, thereby reducing Ics correspondingly. When signal 445 is a logic LOW, Q output 641 becomes a logic LOW and switches-OFF current sink 610.

Power stages of a rail implemented as described above can achieve temperature balance without requiring separate paths from each power stage to phase controller 210. Furthermore, it may be appreciated that the operation of thermal balancing (i.e., balancing of temperatures) can be performed in real-time and continuously for the duration of operation of VRM 110. As a result, the balancing technique can achieve thermal balancing across all load-current and temperature profiles, and may therefore be superior to a static one-time thermal balancing.

It is noted here that one or more of the power switches of a rail may be switched-OFF due to the operation of automatic phase management (APM) by phase controller 210 based, for example, on load-current requirements. The PWM inputs of the corresponding power stages will be in a high-impedance state. Based on this state, the above-noted operations for thermal balance in such power stages are disabled. Thus, the operations for thermal balancing may be enabled only when the power stage is active. Accordingly, each power stage is designed to contain circuitry to determine the state of its PWM input. As an example, gate driver 410 of power stage SPSB1 can be implemented to make such determination and provide a corresponding indication to current-sense block 450, which would perform the under-reporting/over-reporting for achieving temperature balance only if its PWM input is not in the high-impedance state.

Further, thermal balancing operations may be enabled only when the temperature of one or more power stages of a rail crosses a pre-determined temperature limit (e.g., 100 degrees Centigrade). Accordingly, either temperature monitor 440 or phase controller is implemented to contain circuitry to perform such a check in a known way, although not shown in the Figures.

Also, as noted above, any updates by signal 445 may need to be very small and only at a maximum rate of the order of, for example, once every millisecond (ms). Such slow update rate is achieved by clocking FF 640 at a 1 ms rate by use of the 1 ms clock 642.

In alternative embodiments, the driver circuit in each of the power stages can be implemented differently such that the derived magnitude is some other function (than the ‘maximum’) of all the temperature signals. The operation of current-sense block 450 in reporting the sensed inductor-current would correspondingly be either an over-reporting or an under-reporting so as to cause the inductor-current to be decreased or increased to in turn cause the temperatures of the operating power stages to move towards equality.

For example, the derived magnitude could be an average of all the temperature signals of the respective power stages. Depending on the magnitude by which the temperature signal and signal TEMPB differ, current-sense block 450 either under-reports or over-reports the sensed inductor-current with the aim of balancing the temperatures of the power stages. Correspondingly, phase controller 210 would generate PWMB-1 (216) in a manner so as to cause power stage SPSB-1 to either increase or decrease its inductor-current thereby pushing the temperature of power stage SPSB-1 towards the temperature indicated by the signal on TEMPB (219). The other details and operations as noted above with respect to the embodiment in which the common path TEMPB is a maximum of all the temperature signals may be correspondingly applied/performed.

### 6. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1 through 6, although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

It should be appreciated that the specific type of transistors (such as NMOS, PMOS, etc.) noted above are merely by way of illustration. However, alternative embodiments using different configurations and transistors will be apparent to one skilled in the relevant arts by reading the disclosure provided herein. For example, the NMOS transistors may be replaced with PMOS (P-type MOS) transistors, while also interchanging the connections to power and ground terminals.

Accordingly, in the instant application, the power and ground terminals are referred to as constant reference potentials, the source (emitter) and drain (collector) terminals of transistors (though which a current path is provided when turned on and an open path is provided when turned off) are termed as current terminals, and the gate (base) terminal is termed as a control terminal.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A power stage of a plurality of power stages together generating a supply voltage on a power rail of a multi-phase switching converter, wherein a phase controller controls operation of said plurality of power stages, said power stage comprising:
a high-side switch and a low-side switch to respectively drive an inductor in a first interval and a second interval periodically based on a control signal received from a phase controller of said multi-phase switching converter, wherein an actual magnitude flowing through said inductor is determined by ON durations of said high-side switch and said low-side switch as set by said control signal;
a temperature sensor to generate a temperature signal indicative of the temperature of said power stage,
wherein said temperature has a positive correlation with said actual magnitude,
wherein said temperature signal is coupled to be indicated on a common path which indicates to said phase controller a first temperature derived from all of the temperature signals provided by said plurality of power stages;
a comparator to generate a comparison result of a comparison of magnitudes of said temperature signal with said first temperature,
a current-sense block to report, to said phase controller, a first magnitude of current flowing through said inductor,
wherein said phase controller determines said ON durations based on said first magnitude,
wherein, if said comparison result indicates that said magnitudes are unequal, said current sense block reports said first magnitude to be in variance with said actual magnitude to cause said temperature to tend towards said first temperature.

2. The power stage of claim 1, wherein said first temperature is a maximum temperature of those generated by each of said plurality of power stages,
wherein if a temperature represented by said temperature signal is less than said first temperature, said current-sense block reports said first magnitude to be less than said actual magnitude.

3. The power stage of claim 2, wherein in response to receiving said first magnitude when said first magnitude is reported as less than said actual magnitude, said phase controller adjusts said control signal to increase an ON duration of said high-side switch, thereby causing said temperature to increase.

4. The power stage of claim 2, wherein said current-sense block reports said first magnitude to be less than said actual magnitude only if said temperature represented by said temperature signal exceeds a pre-determined limit.

5. The power stage of claim 2, wherein said current-sense block reports said first magnitude to be less than said actual magnitude only if said power stage is active.

6. The power stage of claim 2, wherein said temperature sensor and said comparator are comprised in a temperature monitor of said power stage, wherein said temperature monitor further comprises a driver circuit designed to drive said temperature signal onto a first output pin of said power stage, said first output pin being coupled to said common path,
wherein said driver circuit causes said temperature signal to be provided on said first output pin if said temperature represented by said temperature signal is greater than or equal to said first temperature, said driver circuit decoupling said temperature signal from said first output pin otherwise.

7. The power stage of claim 6, wherein said driver circuit comprises:
a differential amplifier coupled to receive said temperature signal on a non-inverting terminal, an inverting terminal of said differential amplifier coupled to said first output pin;
a first weak current-sink coupled between said non-inverting terminal and a first constant reference potential; and
a first P-channel MOSFET transistor (PMOS), wherein a control terminal of said first PMOS is coupled to an output of said differential amplifier, wherein a first current terminal of said first PMOS is coupled to a second constant reference potential, and a second current terminal of said first PMOS is coupled to said non-inverting terminal of said differential amplifier.

8. The power stage of claim 7, wherein said comparator comprises:
a second PMOS, wherein a control terminal of said second PMOS is coupled to said output of said differential amplifier, wherein a first current terminal of said second PMOS is coupled to said second constant reference potential;
a second weak current-sink coupled between a second current terminal of said second PMOS and said first constant reference potential; and
an inverter having an input terminal coupled between a junction of said second PMOS and said second weak current sink, wherein an output terminal of said inverter is coupled to said current-sense block to enable said current-sense block to report, to said phase controller, said first magnitude,
wherein said output terminal of said inverter has a first logic value if said temperature represented by said temperature signal is greater than or equal to said first temperature, and a second logic value otherwise.

9. The power stage of claim 8, wherein said current-sense block comprises:
a flip-flop, wherein a D input of said flip-flop is coupled to said output terminal of said inverter, wherein a clock input of said flip-flop is coupled to receive a clock signal; and
a third current sink coupled between a second output pin of said power stage and said first constant reference potential, wherein said current-sense block reports said first magnitude to said phase controller via said second output pin, wherein said output terminal of said inverter is coupled to said third current sink,
wherein said second logic value on said output terminal of said inverter causes said third current sink to be switched ON and sink a fixed current from said second output pin, thereby causing said current-sense block to report said first magnitude to be less than said actual magnitude.

10. The power stage of claim 1, wherein said first temperature is an average temperature of the temperature signals generated by each of said plurality of power stages,
wherein if a magnitude of said temperature signal is greater than said average temperature, said current-sense block reports said first magnitude to be greater than said actual magnitude.

11. A multi-phase switching converter comprising:
a plurality of power stages together generating a regulated supply voltage on a power rail; and
a phase controller to control the operation of each of said plurality of power stages to cause generation of said regulated supply voltage,
wherein a first power stage of said plurality of power stages comprises:
a high-side switch and a low-side switch to respectively drive an inductor in a first interval and a second interval periodically based on a control signal received from a phase controller of said multi-phase switching converter, wherein an actual magnitude flowing through said inductor is determined by ON durations of said high-side switch and said low-side switch as set by said control signal;
a temperature sensor to generate a temperature signal indicative of the temperature of said power stage,
wherein said temperature has a positive correlation with said actual magnitude,
wherein said temperature signal is coupled to be indicated on a common path which indicates to said phase controller a first temperature derived from all of the temperature signals provided by said plurality of power stages;
a comparator to generate a comparison result of a comparison of magnitudes of said temperature signal with said first temperature,
a current-sense block to provide information representing a first magnitude of current flowing through said inductor to said phase controller,
wherein said phase controller determines said ON durations based on said first magnitude,
wherein, if said comparison result indicates that said magnitudes are unequal, said current sense block reports said first magnitude to be in variance with said actual magnitude, thereby causing said phase controller to cause said temperature to tend towards said first temperature.

12. The multi-phase switching converter of claim 11, wherein said first temperature is a maximum temperature of those generated by each of said plurality of power stages,
wherein if a temperature represented by said temperature signal is less than said first temperature, said current-sense block reports said first magnitude to be less than said actual magnitude.

13. The multi-phase switching converter of claim 12, wherein in response to receiving said first magnitude when said first magnitude is reported as less than said actual magnitude, said phase controller adjusts said control signal to increase an ON duration of said high-side switch, thereby causing said temperature to increase.

14. The multi-phase switching converter of claim 12, wherein said current-sense block reports said first magnitude to be less than said actual magnitude only if said temperature represented by said temperature signal exceeds a pre-determined limit.

15. The multi-phase switching converter of claim 12, wherein said current-sense block reports said first magnitude to be less than said actual magnitude only if said power stage is active.

16. The multi-phase switching converter of claim 12, wherein said temperature sensor and said comparator are comprised in a temperature monitor of said power stage, wherein said temperature monitor further comprises a driver circuit designed to drive said temperature signal onto a first output pin of said power stage, said first output pin being coupled to said common path,
wherein said driver circuit causes said temperature signal to be provided on said first output pin if said temperature represented by said temperature signal is greater than or equal to said first temperature, said driver circuit decoupling said temperature signal from said first output pin otherwise.

17. The multi-phase switching converter of claim 16, wherein said driver circuit comprises:
a differential amplifier coupled to receive said temperature signal on a non-inverting terminal, an inverting terminal of said differential amplifier coupled to said first output pin;
a first weak current-sink coupled between said non-inverting terminal and a first constant reference potential; and
a first P-channel MOSFET transistor (PMOS), wherein a control terminal of said first PMOS is coupled to an output of said differential amplifier, wherein a first current terminal of said first PMOS is coupled to a second constant reference potential, and a second current terminal of said first PMOS is coupled to said non-inverting terminal of said differential amplifier.

18. The multi-phase switching converter of claim 17, wherein said comparator comprises:
a second PMOS, wherein a control terminal of said second PMOS is coupled to said output of said differential amplifier, wherein a first current terminal of said second PMOS is coupled to said second constant reference potential;
a second weak current-sink coupled between a second current terminal of said second PMOS and said first constant reference potential; and
an inverter having an input terminal coupled between a junction of said second PMOS and said second weak current sink, wherein an output terminal of said inverter is coupled to said current-sense block to enable said current-sense block to report, to said phase controller, said first magnitude,
wherein said output terminal of said inverter has a first logic value if said temperature represented by said temperature signal is greater than or equal to said first temperature, and a second logic value otherwise.

19. The multi-phase switching converter of claim 18, wherein said current-sense block comprises:
a flip-flop, wherein a D input of said flip-flop is coupled to said output terminal of said inverter, wherein a clock input of said flip-flop is coupled to receive a clock signal; and
a third current sink coupled between a second output pin of said power stage and said first constant reference potential, wherein said current-sense block reports said first magnitude to said phase controller via said second output pin, wherein said output terminal of said inverter is coupled to said third current sink,
wherein said second logic value on said output terminal of said inverter causes said third current sink to be switched ON and sink a fixed current from said second output pin, thereby causing said current-sense block to report said first magnitude to be less than said actual magnitude.

20. The multi-phase switching converter of claim 11, wherein said first temperature is an average temperature of the temperature signals generated by each of said plurality of power stages,
wherein if a magnitude of said temperature signal is greater than said average temperature, said current-sense block reports said first magnitude to be greater than said actual magnitude.
